(19) United States
(12) Patent Application Publication
(10) Pub. No.: US 2011/0134122 A1
(43) Pub. Date: Jun. 9, 2011

(54) SYSTEM AND METHOD FOR RAPID WAVE PROPAGATION ANALYSIS USING 3D SPATIAL INDEXING AND 3D CULLING TECHNIQUES

(75) Inventor: Ji Sang PARK, Daejeon (KR)

(73) Assignee: Electronics and Telecommunications Research Institute, Daejeon (KR)

(21) Appl. No.: 12/959,826

(22) Filed: Dec. 3, 2010

(30) Foreign Application Priority Data
Dec. 4, 2009 (KR) 10-2009-0119964
Feb. 5, 2010 (KR) 10-2010-0011136

(51) Int. Cl. G06T 15/50

(52) U.S. Cl. 345/426

(57) ABSTRACT

A rapid wave propagation analysis system using 3D spatial indexing and 3D culling techniques receives input data for wave propagation analysis using a ray tube method. The system divides an analysis region of the input data to generate quad-trees, performs object-separation on the quad-trees, and generates BSP trees with respect to their spatial relationships among objects obtained by the object-separation. The system determines valid reflection surfaces using the 3D culling technique to generate a ray tube tree, thereby searching valid propagation paths, when the generation of the BSP tree is completed.

### CROSS-REFERENCE TO RELATED APPLICATION

This application claims priority to and the benefit of Korean Patent Application Nos. 10-2009-0119964 and 10-2010-0011136 filed in the Korean Intellectual Property Office on Dec. 4, 2009 and Feb. 5, 2010, the entire contents of which are incorporated herein by reference.

### BACKGROUND OF THE INVENTION

(a) Field of the Invention

The present invention relates to a system and method for rapid wave propagation analysis using three dimensional (3D) spatial indexing and 3D culling techniques, and more particularly, to a system and method for rapid wave propagation analysis using 3D spatial indexing and tree techniques, and 3D culling techniques for reducing searching times looking for valid radio paths while providing relatively accurate wave propagation analysis results.

(b) Description of the Related Art

Ray tracing-based wave propagation techniques track a series of radio signals transmitted from and received to different antennae, and is used to analyze a variety of radio characteristics (e.g., signal strength, path loss, and delay spread). This technique is specifically useful for propagation analyses in regions of small area (i.e., micro-cell, or pico-cell) based upon reflections and/or /diffractions among terrain and buildings.

A variety of wave propagation models (e.g., a ray launching method, an image method, and a deterministic ray tube method) has been developed with different ray tracing methods. Among them, wave propagation techniques implemented according to the image method or the deterministic ray tube method have been more commonly and generally used than other methods because of the improved accuracy level of analysis results and the reduced analysis durations.

Significant key issues with the ray tracing-based wave propagation analysis techniques are how to search and calculate the reflections and diffractions of radio signals among building sides and/or building corners. In real, the ray tracing-based wave propagation analysis techniques requires significant amount of searching times for analyzing the reflection and diffraction characteristics among surfaces both from terrain grounds and buildings Without any pre-historic information about the relevant neighborhoods, the ray tracing-based wave propagation analysis techniques need long searching time durations that often is needed for unnecessary searching or for multiple searching within the same regions. In addition, the accuracy level of the analysis results can be improved by identifying valid reflection surfaces and diffraction points on 3D spaces.

Therefore, for commercialized use of the ray tracing-based wave propagation analysis techniques, it is required to develop the advanced wave propagation analysis technique equipped by reduced analysis time duration and improved analysis accuracy.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for rapid wave propagation analysis using 3D spatial indexing and 3D culling techniques that allows reduced analysis time duration and improved accuracy level thereof.

An exemplary embodiment of the present invention provides a system for rapid wave propagation analysis using 3D spatial indexing and 3D culling techniques, comprising:

a spatial division/indexing unit that receives input data for wave propagation analysis, divides analysis regions of the input data to generate quad-trees, performs object-separation with the quad-trees, and generates binary space partitioning (BSP) trees based on spatial relationships among objects obtained by the object-separation; and an electric field strength prediction/visualization unit that determines a valid reflection surfaces using the 3D culling technique to generate a ray tube tree, and searches valid propagation paths using the BSP tree.

Another embodiment of the present invention provides a method for rapid wave analysis using three-dimensions (3D) spatial indexing and 3D culling techniques, comprising:

receiving input data for wave propagation analysis; dividing an analysis region of the input data to generate quad-trees, and perform an object-separation from the quad-trees; generating binary space partitioning (BSP) trees with respect to the spatial relationship among objects obtained by the object-separation; determining valid reflection surfaces using the 3D-culling technique to generate a ray tube tree when the generation of the BSP trees is completed; and searching valid propagation paths by positioning receiving points at locations for predicting electric field strength in the ray tube tree.

### BRIEF DESCRIPTION OF THE DRAWINGS

FIG. 1 is a schematic diagram y showing a rapid wave propagation analysis system according to an exemplary embodiment of the present invention;

FIG. 2 is a schematic diagram of a spatial division/indexing unit shown in FIG. 1;

FIG. 3 is an example of quad-trees according to an exemplary embodiment of the present invention;

FIG. 4 is an example of object separation according to an exemplary embodiment of the present invention;

FIG. 5 is a schematic diagram of BSP tree generation according to an exemplary embodiment of the present invention;

FIG. 6 is a schematic diagram of the electric field strength prediction/visualization unit shown in FIG. 1;

FIG. 7 is an example for searching a valid reflection surface among wall surfaces using the 3D culling technique according to an exemplary embodiment of the present invention;

FIG. 8 is an example for searching valid propagation paths using a ray tube method according to an exemplary embodiment of the present invention;

FIG. 9 is an example of a realistic and visible screen of wave propagation analysis results according to an exemplary embodiment of the present invention; and

FIG. 10 is a sequential diagram for showing a rapid wave propagation analysis based on a ray tube method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

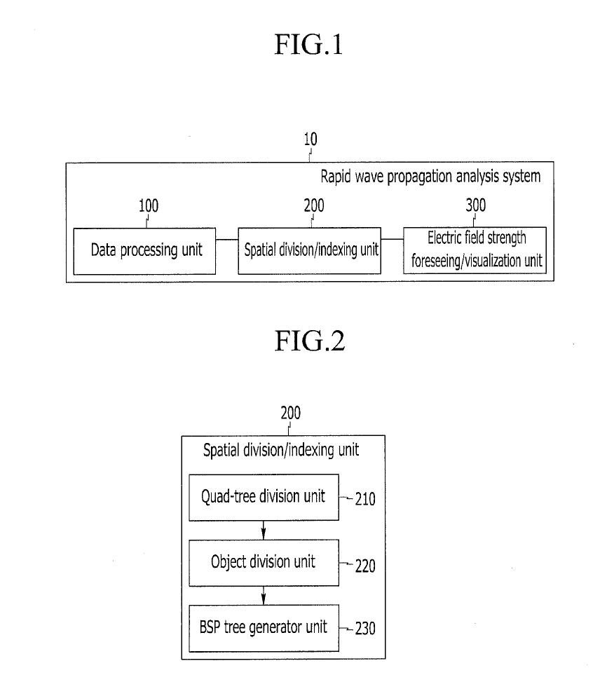

FIG. 1 is a schematic diagram of the rapid wave propagation analysis as the exemplary embodiment of the present invention.

As shown in FIG. 1, the rapid wave propagation analysis system 10 as the exemplary embodiment of the present invention includes a data processing unit 100, a spatial division/indexing unit 200, and an electric field strength prediction/visualization unit 300.

The data processing unit 100 receives, a variety of input data to analyze the propagational characteristics of radio signals by using the ray tube-based approach. The data processing unit 100 transfers the input data to the spatial division/indexing unit 200 for further analyses.

The input data includes 3D terrain models, 3D building models, and orthophotos. 3D terrain models provide numerical representation of a variety of geospatial information (i.e., terrains and ground features), and they are mostly produced by using digital photogrammetry techniques or by processing LiDAR data. 3D building models provides several information about buildings in terms of their size, direction, location, and building texture, and they are mainly generated by processing imagery or by fusing imagery and LiDAR data. Orthophotos contain locational and formal information of terrains and ground features, and thus they are useful to provide actual reality during visualization procedure. They are generated through digital photogrammetry techniques. The techniques of generating input data as the exemplary embodiment of the present invention are well-known and therefore, the detailed descriptions thereof will be omitted.

The spatial division/indexing unit 200 divides the analysis regions using the quad-tree, and separates individual surfaces of all terrain objects. Then, binary space partitioning (BSP) trees are generated based upon the relative positions and directions of among separated surfaces. The spatial division/indexing unit 200 generates the BSP trees and transfers the BSP trees to the electric field strength prediction/visualization unit 300.

The electric field strength prediction/visualization unit 300 creates ray tube trees for searching valid reflecting surfaces from transmitting points by using the BSP trees and determines valid propagation paths up to receiving points. The electric field strength prediction/visualization unit 300 visualizes valid propagation paths onto the input data to complete the wave propagation analysis procedure.

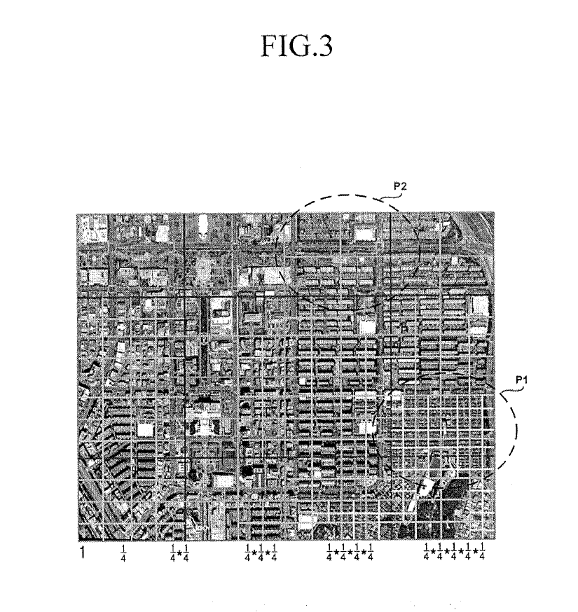

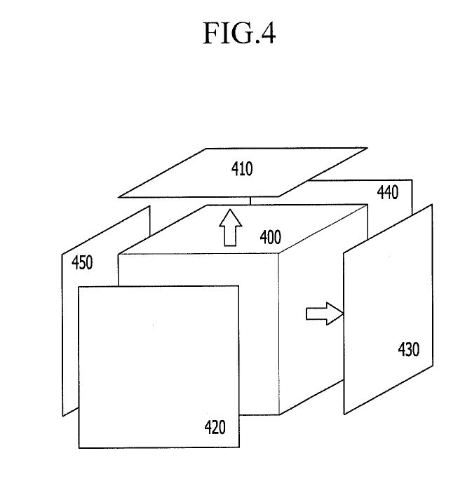

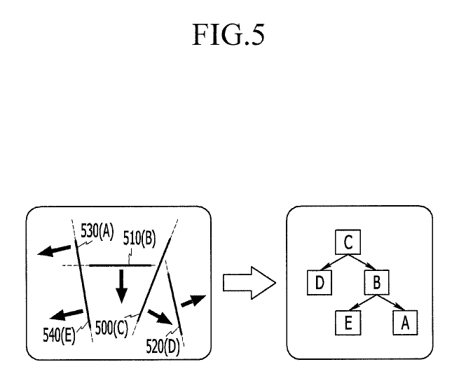

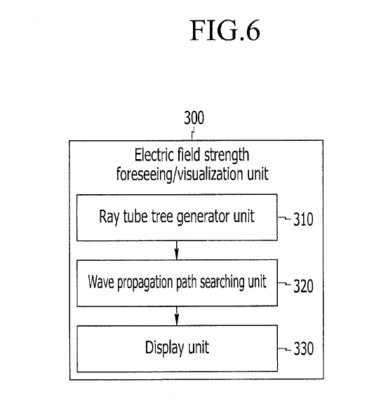

FIG. 2 is a schematic diagram of the spatial division/indexing unit shown in FIG. 1. FIG. 3 is an example of generated quad-trees as the exemplary embodiment of the present invention. FIG. 4 is a diagram of object separations as the exemplary embodiment of the present invention. FIG. 5 is a schematic diagram of showing how to generate a BSP tree as the exemplary embodiment of the present invention.

As shown in FIG. 2, the spatial division/indexing unit 200 as the exemplary embodiment of the present invention includes a quad-tree division unit 210, an object division unit 220, and a BSP tree generator unit 230.

The quad-tree division unit 210 recursively divides the analysis region into four child nodes as shown in FIG. 3. The quad-tree division unit 210 generates the quad-tree by determining the criteria of the spatial division according to the number of surfaces from buildings and terrains at each quad. The region having the large number of surfaces (i.e., point P1) have quad-trees that are consisted of quads of small size, and that having the small number of surfaces (i.e., point P2) have quad-trees that are consisted of quads of large size. The principle reason for using the quad-tree division as the exemplary embodiment of the present invention is to keep the tree structure as balanced while maintaining appropriate number of tree nodes

When quad-trees are generated using the quad-tree division unit 210, the object division unit 220 separates individual surfaces of terrain objects within nodes of each quad. For example, the object division unit 220 divides an arbitrary building 400 into one roof surface 410 and four wall surfaces 420, 430, 440, and 450 as shown in FIG. 4. The object division unit 220 does not include bottom surfaces for computation, and processes each individual surface from terrains in a grid format. This is the process that each individual surface is identified as one object by separating surfaces of buildings and terrains. Then, BSP trees can be created by comparing the relative positions and directions between objects by the BSP tree generator unit 230. Subsequently, valid reflecting surfaces are determined on the 3D coordinate space through 3D-culling process.

The BSP tree generator unit 230 is a binary spatial partitioning tree structure. It determines the relative relationships between all objects within the analysis region, and creates BSP trees based upon the sequence among objects. In other words, the BSP tree generator unit 230 determines the sequential relationships among surfaces based upon their relative positions and directions of objects separated by the object division unit 220. The BSP tree generator unit 230 determines parent nodes among the lowest nodes of quad-trees generated from the quad-tree division unit 210, and determines a child node based upon the correlation with the parent node to generate the BSP tree. At this time, all BSP trees may have a similar tree height and child nodes on the BSP trees are distributed while maintaining the balance between the left and right sides of the trees. As results, almost similar searching time duration is needed for searching the BSP trees in most cases.

For example, as shown in FIG. 5, the BSP tree generator unit 230 determines a C surface 500 as the most preceding and the lowest node based upon the relative positions and directions between the objects that are separated by the object division unit 220, and then determines the C surface 500 as a parent node. Then, the BSP tree generator unit 230 determines a B surface 510 and a D surface 520 as child nodes of the C surface 500 with respect to the correlation with the C surface 500. The BSP tree generator 230 determines an A surface 530 and an E surface 540 as child nodes of the B surface 510 with respect to the correlation with the B surface 510 to generate the BSP tree.

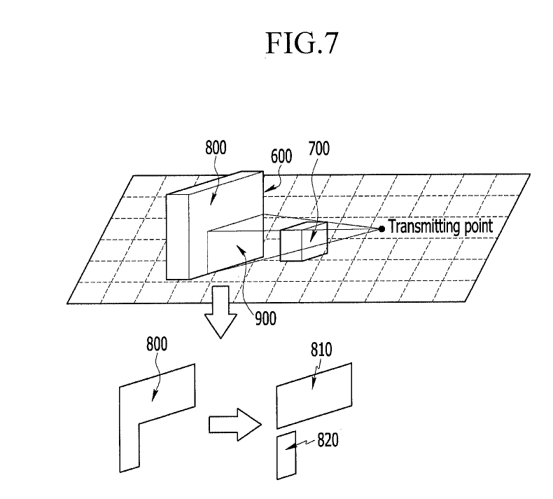

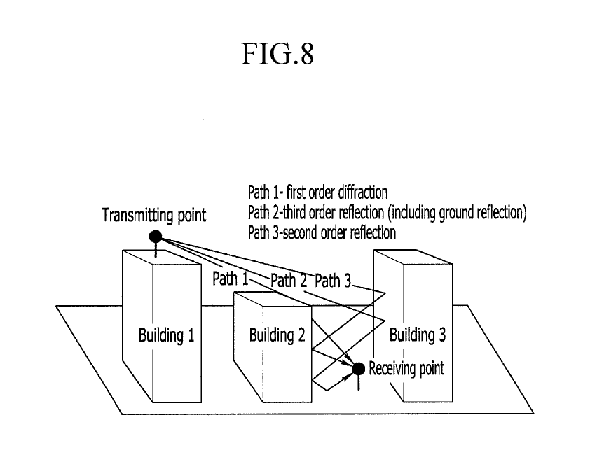

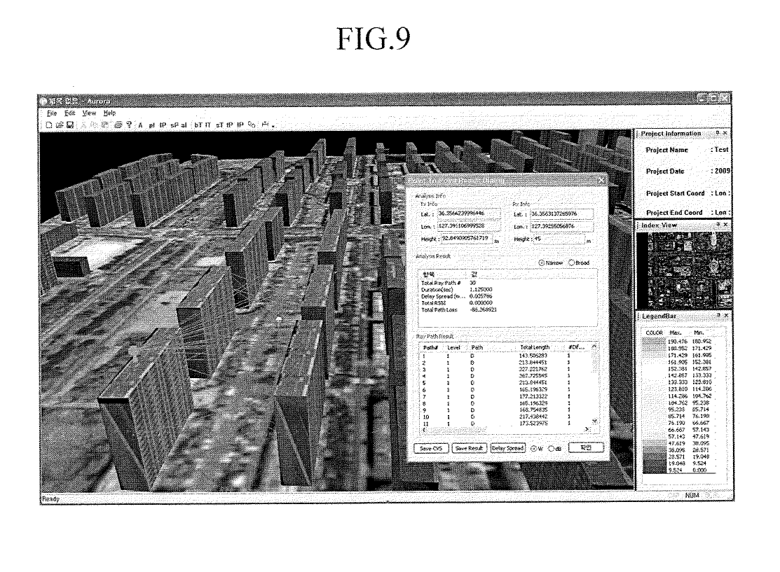

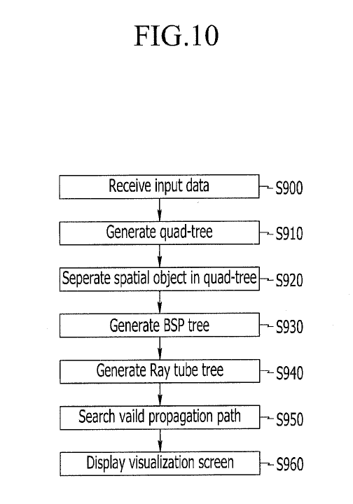

FIG. 6 is a schematic diagram of the electric field strength prediction/visualization unit shown in FIG. 1. FIG. 7 shows an example of searching only a valid reflecting surface from the entire wall surface using a 3D culling technique as the exemplary embodiment of the present invention. FIG. 8 is a diagram showing one example of a valid propagation path search process using a ray tube method as the exemplary embodiment of the present invention. FIG. 9 is a diagram showing one example of a realistic and visible screen of wave propagation results as the exemplary embodiment of the present invention.

As shown in FIG. 6, according to the exemplary embodiment of the present invention, the electric field strength prediction/visualization unit 300 includes a ray tube tree generator unit 310, a propagation path searching unit 320, and a display unit 330.

When generating BSP trees are completed, the ray tube tree generator unit 310 determines valid reflection surfaces and valid diffraction points from the BSP trees using the 3D culling technique, and the unit 310 generates a ray tube tree while considering the positions and directions of the valid reflection surfaces and the valid diffraction points using the ray tube method. Specifically, when an initial position of a transmitting point is determined, the ray tube tree generator unit 310 searches the wall surface at which the first ray from the transmitting point may arrive and then, determines the valid reflection surface and the valid diffraction point with respect to other wall surfaces at which the ray may or may not arrive based upon the reflection and diffraction characteristics.

For example, when a wall surface 600 of a building is covered by an obstacle 700 as shown in FIG. 7, the ray tube tree generator unit 310 generates the ray tube tree based using the 3D culling technique so that a region 900 is removed from further searching, since it is actually covered between the wall surface 600 and the obstacle 700. Therefore, the valid reflection surface 800 is determined. Since it is so difficult to compute the non-uniformed geometrical shape of the surface 800, the ray tube tree generator unit 310 divides the valid reflection surface 800 into the two regions 810 and 820 that have rectangular shape, and the unit 310 stores each regions separately having rectangular shape on the ray tube tree.

The exemplary embodiment of the present invention generates the ray tube tree that is used to determine valid reflection and diffraction surfaces using the 3D culling technique, and therefore allows to secure the sufficient number of valid propagation paths for electromagnetic field estimation and to assist to provide accurate analysis results.

When generating the ray tube tree is completed by the ray tube tree generator unit 310, the propagation path searching unit 320 searches all potential valid propagation paths through which the rays launched from a transmitting point may arrive at a receiving point by regarding reflections and diffractions. One example is shown in FIG. 8. The technology for searching valid propagation paths according to the exemplary embodiment of the present invention is known and thus, the detailed description thereof will be omitted.

When searching valid propagation paths is completed by the propagation path searching unit 320, the display unit 330 generates virtual screen display by using the input data including 3D terrain models, 3D building models, and orthophotos to provide realistic visualization with searched valid propagation paths. The display unit 330 projects valid propagation paths between transmitting and receiving points and show realistic visualization results of the wave propagation analysis.

For example, the display unit 330 shows 3D terrain models on the lowest portion as shown in FIG. 9, then projects orthophotos to visualize the natural terrain, and then, show 3D building models with a variety of wall surface texture information. The display unit 330 can show the realistic visualization result of the wave propagation analysis results by projecting valid propagation paths between transmitting and receiving points.

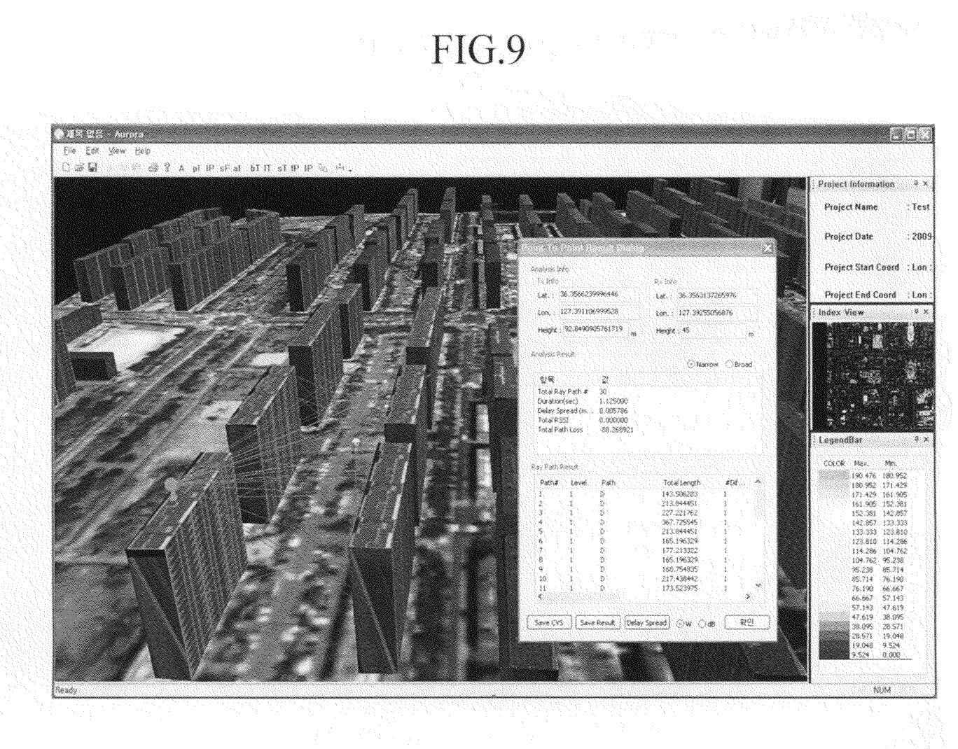

FIG. 10 is a flow chart showing the sequence of rapid wave propagation analysis based upon the ray tube method as the exemplary embodiment of the present invention.

As shown in FIG. 10, according to the exemplary embodiment of the present invention, the data processor 100 in the rapid wave propagation analysis system 10 receives the input data requiring the wave propagation analysis from the user (S900).

The spatial division/indexing unit 200 in the system 10 recursively divides the analysis region of the input data into four child nodes to generate the quad-tree (S910). The spatial division/indexing unit 200 separate individual surfaces of the spatial objects belong to each node of the quad-tree (S920). The spatial division/indexing unit 200 determines the relative relationships among all objects within the analysis region, and generates the BSP trees based upon the sequence between objects (S930).

When generating BSP trees is completed and the initial position of a transmitting point is determined, the electric field strength prediction/visualization unit 300 in the system 10 determines valid reflection surfaces from the BSP tree and generates the ray tube tree (S940). When generating ray tube tree is completed, the electric field strength prediction/visualization unit 300 searches all possible valid propagation paths through between transmitting and receiving points while considering reflections and diffractions (S950). The electric field strength prediction/visualization unit 300 generates the virtual screen by using input data and shows their results of valid propagation paths (S960).

As described above, according to the exemplary embodiment of the present invention, the rapid wave propagation analysis system 10 can perform quad tree generation, object separation, and can reduce searching time for finding valid propagation paths by reducing the processing times that is required to generate a ray tube tree In addition, the accuracy of wave propagation estimation can be improved by using the ray tube method-based wave propagation analysis procedure assisted by the 3D culling technique.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rapid wave propagation analysis system using three-dimensions (3D) spatial indexing and 3D culling techniques, comprising:
a spatial division/indexing unit that receives input data for wave propagation analysis, divides analysis regions of the input data to generate quad-trees, performs object-separation with the quad-trees, and generates binary space partitioning (BSP) trees based on spatial relationships among objects obtained by the object-separation; and
an electric field strength prediction/visualization unit that determines a valid reflection surfaces using the 3D culling technique to generate a ray tube tree, and searches valid propagation paths using the BSP trees.

2. The system of claim 1, wherein:
the spatial division/indexing unit includes
a quad-tree division unit that divides the analysis region into a predetermined number of child nodes to generate the quad-trees.

3. The system of claim 2, wherein:
the quad-tree division unit generates the quad-trees based on a number of wall surfaces from buildings and terrains, and
wherein a number of quads within the regions having larger number of surfaces from buildings and terrains is greater than that within the regions having smaller number of surfaces from buildings and terrains.

4. The system of claim 1, wherein:
the spatial division/indexing unit includes
an object division unit for performing the object-separation that separates individual surfaces belongs to each node of quad-trees and processes individual surfaces separately.

5. The system of claim 1, wherein:
the spatial division/indexing unit includes
a BSP tree generator unit that determines relationships among all objects within the analysis region to generate the BSP trees, when the object separation is completed.

6. The system of claim 5, wherein:
the parent node of the BSP trees is determined among the lowest nodes of the quad-trees.

7. The system of claim 6, wherein:
the spatial division/indexing unit
determines child nodes from the parent node based upon the sequential relationship among surfaces

8. The system of claim 1, wherein:
the electric field strength prediction/visualization unit includes
when wall-surfaces of buildings within analysis regions are covered by obstacles,
a ray tube tree generator unit that determines valid reflection surfaces by removing non-reflection surfaces, which are covered between wall surfaces of buildings and obstacles using the 3D culling technique while generating BSP trees are completed and the transmitting points are determined, wherein the ray tube trees are generated from individually separated objects from the valid reflection surfaces.

9. The system of claim 8, wherein:
the electric field strength prediction/visualization unit includes
a propagation path searching unit that searches valid propagation paths between transmitting and receiving points.

10. The system of claim 9, wherein:
the electric field strength prediction/visualization unit includes
a display unit that generates a virtual screen using input data and shows the wave propagation analysis by projecting the valid propagation paths between transmitting and receiving points.

11. The system of claim 1, wherein:
the input data includes 3D terrain models, 3D building models, and orthophotos.

12. A rapid wave propagation analysis method using three-dimensions (3D) spatial indexing and 3D culling technique, comprising:
receiving input data for the wave propagation analysis; dividing an analysis region of the input data to generate quad-trees and perform an object-separation from the quad-trees;
generating binary space partitioning (BSP) trees with respect to the spatial relationships among objects obtained by the object-separation;
determining valid reflection surfaces using the 3D-culling technique to generate a ray tube tree when the generation of the BSP trees is completed; and
searching valid propagation paths by positioning receiving points at locations for predicting electric field strength in the ray tube tree.

13. The method claim 12, wherein:
the object-separation includes
generating quad-trees by recursively dividing the analysis region into child nodes; and
separating each individual objects within each node of the quad-trees.

14. The method of claim 12, wherein:
the generating BSP trees includes
determining spatial relationships among all objects within the analysis region when the object-separation is completed,
determining a parent node among the lowest node of the quad-trees based upon the spatial relationship; and
determining child nodes with respect to the sequence from their parent node.

15. The method of claim 12, wherein:
the generating ray tube tree includes
determining valid reflection surfaces by removing non-reflection surfaces covered between wall surfaces of buildings and obstacles, when transmitting points are determined; and
dividing valid reflection surfaces into portions to generate the ray tube tree.

16. The method of claim 15, wherein:
the searching valid propagation path includes
positioning receiving points to predict the electric field intensity, when generating ray tube tree is completed, and
searching valid propagation paths between transmitting and receiving points.

17. The method of claim 12, wherein:
the input data includes 3D terrain models, 3D building models, and orthophotos.
